(19) United States
(12) Patent Application Publication
(10) Pub. No.: US 2023/0079837 A1
(43) Pub. Date: Mar. 16, 2023

(54) OPTICAL INTERFERENCE RANGE SENSOR

(71) Applicant: OMRON Corporation, Kyoto-shi (JP)

(72) Inventors: Kazuya KIMURA, Kyoto-shi (JP); Masayuki HAYAKAWA, Kyoto-shi (JP); Yusuke NAGASAKI, Kyoto-shi (JP)

(73) Assignee: OMRON Corporation, Kyoto-shi (JP)

(21) Appl. No.: 17/896,116

(22) Filed: Aug. 26, 2022

(30) Foreign Application Priority Data
Sep. 15, 2021 (JP) 2021-150053

(51) Int. Cl. G01S 17/08; G01S 7/481

(52) U.S. Cl. CPC G01S 17/08; G01S 7/4818

(57) ABSTRACT

An optical interference range sensor includes a wavelength-swept light source, an optical coupler, an interferometer, a light-receiving unit, a processor, and a reflection point that reflects a light beam that is split and proceeds to a fourth port of the optical coupler, of a light beam projected from the wavelength-swept light source and input to a first port of the optical coupler. One or more of an optical path length, denoted by L1, from the third port of the optical coupler to the reference surface, an optical path length, denoted by L2, from the fourth port of the optical coupler to the reflection point, an optical path length, denoted by LH, from the reference surface to a leading end of a sensor head configured to radiate the measurement beam toward the measurement target, and a measurement range, denoted by R, for the measurement target may be set such that the expression L1−L2>(LH+R)*2 or L1−L2<LH*2 is satisfied.

### CROSS-REFERENCES TO RELATED APPLICATIONS

This application claims priority to Japanese Patent Application No. 2021-150053 filed on Sep. 15, 2021, the entire contents of which are incorporated herein by reference.

### FIELD

The disclosure relates to an optical interference range sensor.

### BACKGROUND

In recent years, optical range sensors that contactlessly measure the distance to a measurement target have been widely used. For example, known optical range sensors include optical interference range sensors that generate an interference beam by interference between a reference beam and a measurement beam from a light beam projected from a wavelength-swept light source and measure the distance to a measurement target based on the interference beam.

There is a demand for a reduction of noise generated in the waveform of an interference signal in this type of optical interference range sensor since this noise may lower the measurement accuracy.

The optical interference unit described in JP 2018-205203A below has a reference beam device. Constituent devices of the optical interference unit are arranged so that the transmitted beam optical path length of a reference beam that is transmitted through the reference beam device, from the reference beam device to a multiplexing optical element is not smaller than the optical path of a reference beam reflected by a departing section of the reference beam device, from the reference beam device to the multiplexing optical element.

This configuration reduces noise generated on the overall waveform of an interference signal in the optical interference unit described in JP 2018-205203A.

JP 2018-205203A is an example of background art.

### SUMMARY

However, the optical interference unit disclosed in JP 2018-205203A reduces noise generated on the overall waveform of the interference signal by adjusting the optical path length through the arrangement of its constituent devices, but has not clarified the causes of the noise. There is a problem in that this optical interference unit cannot appropriately eliminate the noise that affects measurement of a measurement target.

One or more embodiments may provide an optical interference range sensor capable of measuring distance with high accuracy by eliminating noise that affects measurement of a measurement target.

An optical interference range sensor according to one or more embodiments includes: an optical coupler having at least four ports and configured to split a light beam and to couple light beams; a light source connected to a first port of the optical coupler and configured to project a light beam while continuously varying a wavelength thereof; an interferometer configured to generate an interference beam by interference between a first reflected beam and a second reflected beam, the first reflected beam being obtained as a result of a light beam that is split and proceeds to a third port of the optical coupler, of the light beam projected from the light source and input to the first port of the optical coupler, being radiated as a measurement beam toward a measurement target and reflected at the measurement target, the second reflected beam being obtained as a result of a reference beam, of the light beam that is split and proceeds to the third port of the optical coupler, being reflected at a reference surface; a reflection point configured to reflect a light beam that is split and proceeds to a fourth port of the optical coupler, of the light beam projected from the light source and input to the first port of the optical coupler; a light-receiving unit configured to receive a light beam obtained as a result of the interference beam from the third port and a reflected beam reflected at the reflection point from the fourth port being coupled and output to a second port of the optical coupler, and to convert the received light beam into an electrical signal; and a processor configured to calculate a distance to the measurement target based on the electrical signal converted by the light-receiving unit. One or more of an optical path length, denoted by L1, from the third port of the optical coupler to the reference surface, an optical path length, denoted by L2, from the fourth port of the optical coupler to the reflection point, an optical path length, denoted by LH, from the reference surface to a leading end of a sensor head configured to radiate the measurement beam toward the measurement target, and a measurement range, denoted by R, for the measurement target may be set such that the expression L1−L2>(LH+R)*2 or L1−L2<LH*2 is satisfied.

According to one or more embodiments, the optical coupler, the interferometer that includes the sensor head, and the optical fiber cable that connects them are configured and arranged so as to satisfy L1−L2>(LH+R)*2 or L1−L2<LH*2. With this configuration, noise that affects the measurement of the measurement target may be eliminated from the measurement range for the measurement target in the signal waveform of the light beam that is received by the light-receiving unit and used by the processor to calculate the distance to the measurement target. As a result, distance measurement may be carried out with high accuracy.

In one or more embodiments, the reference surface may be an end face of an optical fiber cable connecting the third port of the optical coupler to the sensor head.

According to one or more embodiments, the light beam output from the third port of the optical coupler is transmitted through the optical fiber cable, and a part of this light beam serves as a reference beam and reflected at the end face of the optical fiber cable. This reflected beam may be used as the second reflected beam and cause an interference beam together with the first reflected beam reflected at the measurement target.

In one or more embodiments, of the light beam projected from the light source and input to the first port of the optical coupler, the power of the light beam that is split and proceeds to the third port of the optical coupler may be smaller than the power of the light beam that is split and proceeds to the fourth port.

According to one or more embodiments, the power of the light beam that is split and proceeds to the second port, of a return beam from the interferometer that is input to the third port of the optical coupler, is larger. Therefore, the light-receiving unit receives a large amount of light, and the processor may calculate the distance to the measurement target more appropriately.

In one or more embodiments, the optical interference range sensor further may include an optical amplifier configured to amplify the light beam projected from the light source, the optical amplifier being located between the light source and the first port of the optical coupler.

According to one or more embodiments, the optical amplifier may amplify the light beam projected by the light source, thus enabling adjustment of the power of the measurement beam radiated toward the measurement target. That is to say, the optical amplifier may enable the light-receiving unit to receive a necessary amount of light for measuring the distance to the measurement target while ensuring safety by adjusting the power of the light beam received by light-receiving unit while maintaining an eye-safe laser, for example.

In one or more embodiments, the reflection point may be a terminator.

According to one or more embodiments, reflected beams proceeding to the optical coupler may be reduced by using the terminator to attenuate the light beam that is split and proceeds to the fourth port of the optical coupler. As a result, it may be possible to reduce noise that affects the measurement of the measurement target and carry out distance measurement with higher accuracy.

In one or more embodiments, the reflection point may be an isolator.

According to one or more embodiments, return beams proceeding to the optical coupler may be suppressed by using the isolator to transmit, to another system, the light beam that is split and proceeds to the fourth port of the optical coupler. As a result, it may be possible to reduce noise that affects the measurement of the measurement target and carry out distance measurement with higher accuracy.

In one or more embodiments, the optical interference range sensor may further include: a second optical coupler configured to split a light beam and to couple light beams, and having at least four ports including a first port connected to the isolator; a second interferometer configured to generate a second interference beam by interference between a third reflected beam and a fourth reflected beam, the third reflected beam being obtained as a result of a light beam that is split and proceeds to a third port of the second optical coupler, of a light beam guided by the isolator and input to the first port of the second optical coupler, being radiated as a measurement beam toward a measurement target and reflected at the measurement target, the fourth reflected beam being obtained as a result of a reference beam, of the light beam that is split and proceeds to the third port of the second optical coupler, being reflected at a reference surface; a second reflection point configured to reflect a light beam that is split and proceeds to a fourth port of the second optical coupler, of the light beam guided by the isolator and input to the first port of the second optical coupler; a second light-receiving unit configured to receive a light beam obtained as a result of the second interference beam from the third port of the second optical coupler and a reflected beam reflected at the second reflection point from the fourth port of the second optical coupler being coupled and output to a second port of the second optical coupler, and to convert the received light beam into an electrical signal; and a second processor configured to calculate a distance to the measurement target based on the electrical signal converted by the second light-receiving unit.

According to one or more embodiments, the light beam that is split and proceeds to the fourth port of the optical coupler is input to the first port of the second optical coupler via the isolator. The second optical coupler, the second interferometer, the second light-receiving unit, and the second processor may enable the measurement of the distance to the measurement target. In other words, this optical interference range sensor functions as an optical interference range sensor having multiple heads with a multi-stage configuration. Therefore, distance measurement may be carried out with higher accuracy based on the distances to the measurement target calculated by the processor and the second processor.

According to one or more embodiments, it may be possible to provide an optical interference range sensor capable of measuring the distance to a measurement target with high accuracy by eliminating noise that affects the measurement.

### BRIEF DESCRIPTION OF THE DRAWINGS

FIG. 1 is a schematic diagram illustrating an external appearance of an outline of a displacement sensor according to one or more embodiments.

FIG. 2 is a flowchart illustrating a procedure for measuring a measurement target with use of a displacement sensor according to one or more embodiments.

FIG. 3 is a functional block diagram illustrating an overview of a sensor system that uses a displacement sensor according to one or more embodiments.

FIG. 4 is a flowchart illustrating a procedure for measuring a measurement target with use of a sensor system that uses a displacement sensor according to one or more embodiments.

FIG. 5 is a diagram illustrating a principle by which a displacement sensor according to one or more embodiments measures a target object.

FIG. 6A is a diagram illustrating a perspective view of a schematic configuration of a sensor head.

FIG. 6B is a diagram illustrating a perspective view of a schematic configuration of a collimating lens holder arranged within a sensor head.

FIG. 6C is a diagram illustrating a cross-sectional view of an internal structure of a sensor head.

FIG. 7 is a block diagram illustrating signal processing performed by a controller.

FIG. 8 is a flowchart illustrating a method for calculating a distance to a measurement target that is executed by a processor of a controller.

FIG. 9A is a diagram illustrating how a waveform signal (voltage vs time) is subjected to frequency conversion into a spectrum (voltage vs frequency).

FIG. 9B is a diagram illustrating how a spectrum (voltage vs frequency) is subjected to distance conversion into a spectrum (voltage vs distance).

FIG. 9C is a diagram illustrating how a value (distance, SNR) corresponding to a peak is calculated based on a spectrum (voltage vs distance).

FIG. 10 is a schematic diagram illustrating a schematic configuration of an optical interference range sensor according to a first embodiment or embodiments.

FIG. 11 is a diagram illustrating a configuration and an arrangement of an optical coupler, an interferometer, and an optical fiber cable that connects them in a optical interference range sensor.

FIG. 12 a diagram illustrating a relationship between a signal waveform received by a light-receiving unit and processed by a processor and a measurement range for a measurement target that is calculated by a processor.

FIG. 13 is a schematic diagram illustrating an overview of a configuration of an optical interference range sensor, such as an optical interference range sensor shown in FIG. 10, that additionally includes an optical amplifier.

FIG. 14 is a schematic diagram illustrating an overview of a configuration of an optical interference range sensor, such as an optical interference range sensor such as shown in FIG. 10, with a terminator connected to an end of an optical fiber cable that is connected to a fourth port D of an optical coupler.

FIG. 15 is a schematic diagram illustrating an overview of a configuration of an optical interference range sensor according to a second embodiment or embodiments.

### DETAILED DESCRIPTION

One or more embodiments will be described in detail with reference to the attached drawings. Note that the following embodiments are only for giving specific examples for carrying out the invention, and are not intended to interpret the present invention in a limited manner. To facilitate understanding of the description, the same constituent elements in the drawings are assigned the same signs to the extent possible, and redundant descriptions may be omitted.

### Summary of Displacement Sensor

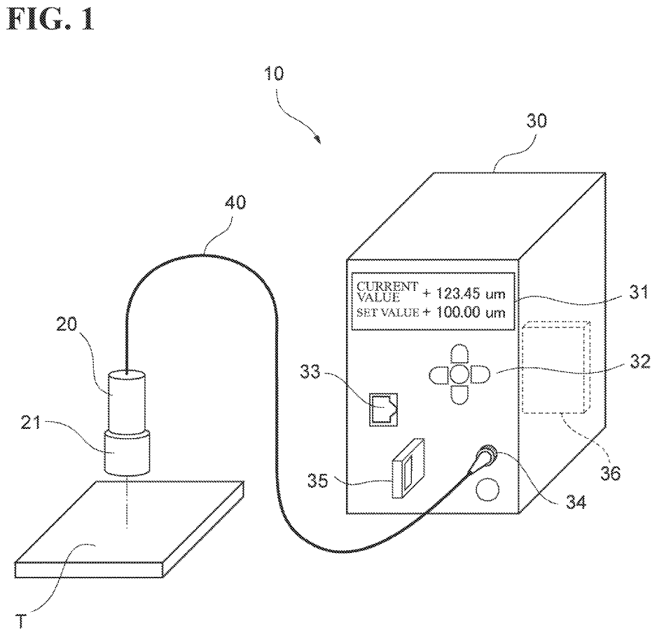

Firstly, a summary of a displacement sensor according to the present disclosure will be described. FIG. 1 is a schematic diagram of an external appearance showing an outline of a displacement sensor 10 according to the present disclosure. As shown in FIG. 1, the displacement sensor 10 includes a sensor head 20 and a controller 30, and measures displacement of a measurement target T (distance to the measurement target T).

The sensor head 20 and the controller 30 are connected by an optical fiber cable 40. An objective lens 21 is attached to the sensor head 20. The controller 30 includes a display unit 31, a setting unit 32, an external interface (I/F) unit 33, an optical fiber cable connector 34, and an external storage unit 35, and also contains a measurement processing unit 36.

The sensor head 20 radiates a light beam output from the controller 30 toward the measurement target T, and receives a reflected beam from the measurement target T. The sensor head 20 contains reference surfaces for reflecting a light beam that is output from the controller 30 and received via the optical fiber cable 40 and causing this reflected beam to interfere with the aforementioned reflected beam from the measurement target T.

Note that the objective lens 21 attached to the sensor head 20 is removable. The objective lens 21 can be replaced by another objective lens having an appropriate focal length in accordance with the distance between the sensor head 20 and the measurement target T. Alternatively, a variable-focus objective lens may be used.

Furthermore, when the sensor head 20 is installed, a guide beam (visible light) may be radiated toward the measurement object T, and the sensor head 20 and/or the measurement object T may be placed so that the measurement object T is appropriately positioned within a measurement area of the displacement sensor 10.

The optical fiber cable 40 is connected to the optical fiber cable connector 34 arranged on the controller 30 and connects the controller 30 to the sensor head 20. The optical fiber cable 40 thus guides a light beam projected from the controller 30 to the sensor head 20 and also guides return beams from the sensor head 20 to the controller 30. Note that the optical fiber cable 40 can be attached to and detached from the sensor head 20 and the controller 30, and may be an optical fiber with any of various lengths, thicknesses, and characteristics.

The display unit 31 is a liquid crystal display, an organic EL display, or the like, for example. The display unit 31 displays set values for the displacement sensor 10, the amount of light of return beams from the sensor head 20, and measurement results such as displacement of the measurement target T (distance to the measurement target T) measured by the displacement sensor 10.

The setting unit 32 allows a user to operate a mechanical button or a touch panel, for example, to configure settings necessary for measuring the measurement target T. Some or all of these necessary settings may be configured in advance, or may be configured from an externally connected device (not shown) that is connected to the external I/F unit 33. The externally connected device may be connected by wire or wirelessly via a network.

Here, the external I/F unit 33 is constituted by, for example, Ethernet (registered trademark), RS232C, analog output, or the like. The external I/F unit 33 may be connected to another connection device so that necessary settings are configured from the externally connected device, and may also output the results of measurement performed by the displacement sensor 10 to the externally connected device, for example.

Further, settings necessary for measuring the measurement target T may also be configured by the controller 30 retrieving data stored in the external storage unit 35. The external storage unit 35 is an auxiliary storage device such as a USB (Universal Serial Bus) memory. Settings or the like necessary for measuring the measurement target T are stored therein in advance.

The measurement processing unit 36 in the controller 30 includes, for example, a wavelength-swept light source that projects a light beam while continuously varying the wavelength, light-receiving elements that receive return beams from the sensor head 20 and convert the received beams to an electrical signal, a signal processing circuit that processes the electrical signal, and the like. The measurement processing unit 36 performs various processes using a controller, a storage, and the like based on return beams from the sensor head 20 so that the displacement of the measurement target T (distance to the measurement target T) is ultimately calculated. The details of the processing will be described later.

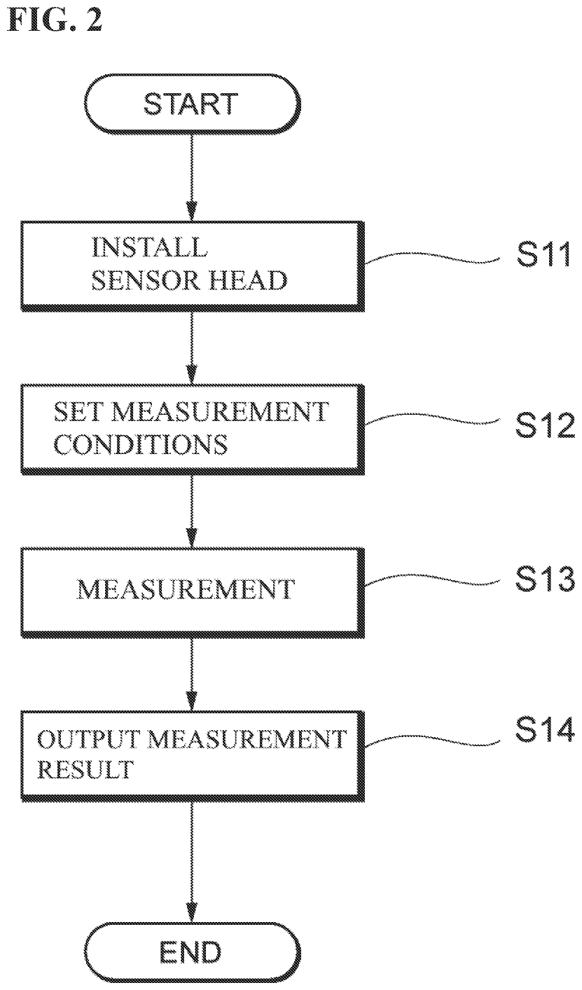

FIG. 2 is a flowchart showing a procedure for measuring a measurement target T with use of the displacement sensor 10 according to the present disclosure. The procedure includes steps S11 to S14, as shown in FIG. 2.

In step S11, the sensor head 20 is installed. For example, a guide beam is radiated from the sensor head 20 toward the measurement target T, and the sensor head 20 is installed at an appropriate position while referencing the radiated guide light.

Specifically, the amount of light of return beams received from the sensor head 20 may be displayed in the display unit 31 in the controller 30. The user may also adjust the orientation of the sensor head 20, the distance (height position) to the measurement target T, or the like while checking the amount of received light. Basically, if the light beam from the sensor head 20 is radiated more vertically (at an angle closer to vertical) relative to the measurement target T, the amount of light of reflected beams from the measurement target T becomes larger, and the amount of light of return beams received from the sensor head 20 also becomes larger.

The objective lens 21 may also be replaced with one having an appropriate focal length in accordance with the distance between the sensor head 20 and the measurement target T.

If appropriate settings cannot be configured (e.g., a necessary amount of received light for measurement cannot be obtained, or the focal length of the objective lens 21 is inappropriate etc.) when the measurement target T is measured, the user may be notified by displaying an error message, an incomplete setting message, or the like in the display unit 31 or outputting such a message to the externally connected device.

In step S12, various measurement conditions are set to measure the measurement target T. For example, the user sets unique calibration data (function etc. for correcting linearity) that the sensor head 20 has by operating the setting unit 32 in the controller 30.

Various parameters may also be set. For example, the sampling time, the measurement range, a threshold for determining whether to regard measurement results as normal or abnormal, or the like are set. Further, a measurement period may be set in accordance with characteristics of the measurement target T, such as the reflectance and material of the measurement target T, and a measurement mode or the like corresponding to the material of the measurement target T may also be set.

Note that these measurement conditions and various parameters are set by operating the setting unit 32 in the controller 30, but may alternatively be set from the externally connected device or may be set by retrieving data from the external storage unit 35.

In step S13, the measurement target T is measured with the sensor head 20 installed in step S11 in accordance with the measurement conditions and various parameters that are set in step S12.

Specifically, in the measurement processing unit 36 in the controller 30, the wavelength-swept light source projects a light beam, the light-receiving elements receive return beams from the sensor head 20, the signal processing circuit performs, for example, frequency analysis, distance conversion, peak detection, and the like to calculate displacement of the measurement target T (distance to the measurement target T). The details of specific measurement processing will be described later.

In step S14, the result of measurement in step S13 is output. For example, the displacement of the measurement target T (distance to the measurement target T) or the like measured in step S13 is displayed in the display unit 31 in the controller 30 or output to the externally connected device.

In addition, whether the displacement of the measurement target T (distance to the measurement target T) measured in step S13 is in a normal range or is abnormal based on the threshold set in step S12 may also be displayed or output as a measurement result. Furthermore, the measurement conditions, various parameters, the measurement mode, or the like that are set in step S12 may also be displayed or output together.

Overview of a System that Includes Displacement Sensor

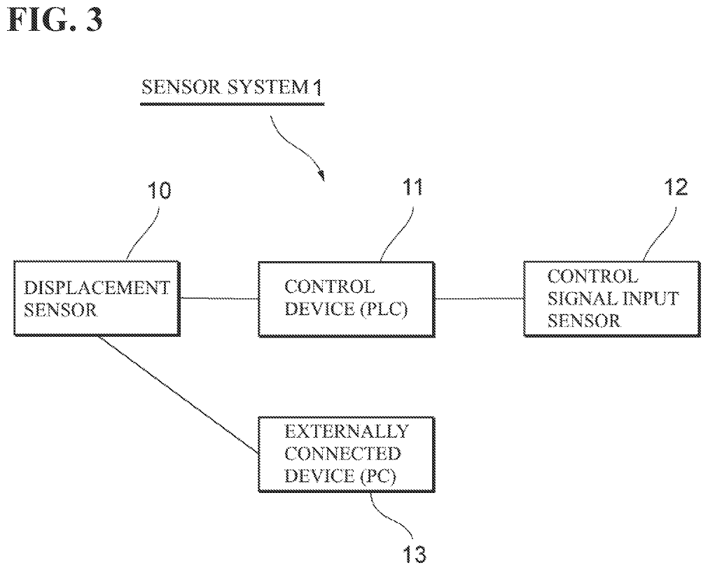

FIG. 3 is a functional block showing an overview of a sensor system 1 that uses the displacement sensor 10 according to one or more embodiments. The sensor system 1 includes the displacement sensor 10, a control device 11, a control signal input sensor 12, and an externally connected device 13, as shown in FIG. 3. Note that the displacement sensor 10 is connected to the control device 11 and the externally connected device 13 by a communication cable or an external connection code (which may include an external input line, an external output line, a power line, etc.), for example. The control device 11 and the control signal input sensor 12 are connected by a signal line.

The displacement sensor 10 measures displacement of the measurement target T (distance to the measurement target T), as described with reference to FIGS. 1 and 2. The displacement sensor 10 may also output the measurement results or the like to the control device 11 and the externally connected device 13.

The control device 11 is a PLC (Programmable Logic Controller), for example, and gives the displacement sensor 10 various instructions when the displacement sensor 10 measures the measurement target T.

For example, the control device 11 may output a measurement timing signal to the displacement sensor 10 based on an input signal from the control signal input sensor 12 connected to the control device 11, and may also output a zero-reset command signal (a signal for setting a current measurement value to 0) or the like to the displacement sensor 10.

The control signal input sensor 12 outputs, to the control device 11, an on/off signal to indicate the timing for the displacement sensor 10 to measure the measurement target T. For example, the control signal input sensor 12 may be installed near a production line in which the measurement target T moves, and may output the on/off signal to the control device 11 in response to detecting that the measurement target T has moved to a predetermined position.

The externally connected device 13 is a PC (Personal Computer), for example. The user can configure various setting to the displacement sensor 10 by operating the externally connected device 13.

As a specific example, the measurement mode, the work mode, the measurement period, the material of the measurement target T, and the like are set.

An “internally synchronized measurement mode”, in which measurement periodically starts within the control device 11, or an “externally synchronized measurement mode”, in which measurement starts in response to an input signal from outside the control device 11, or the like can be selected as a setting of the measurement mode.

An “operation mode”, in which the measurement target T is actually measured, an “adjustment mode”, in which measurement conditions for measuring the measurement target T are set, or the like can be selected as a work mode setting.

The “measurement period” refers to a period for measuring the measurement target T and may be set in accordance with the reflectance of the measurement target T. Even if the measurement target T has a low reflectance, the measurement target T can be appropriately measured by lengthening the measurement period to set an appropriate measurement period.

As a mode for the measurement target T, a “rough surface mode”, which is suitable when the components of the reflected beam reflected from the measurement target T include a relatively large diffuse reflection, a “specular mode”, which is suitable when the components of the reflected beam include a relatively large specular reflection, an intermediate “standard mode”, or the like can be selected.

Thus, the measurement target T can be measured with higher accuracy by configuring appropriate settings in accordance with the reflectance and material of the measurement target T.

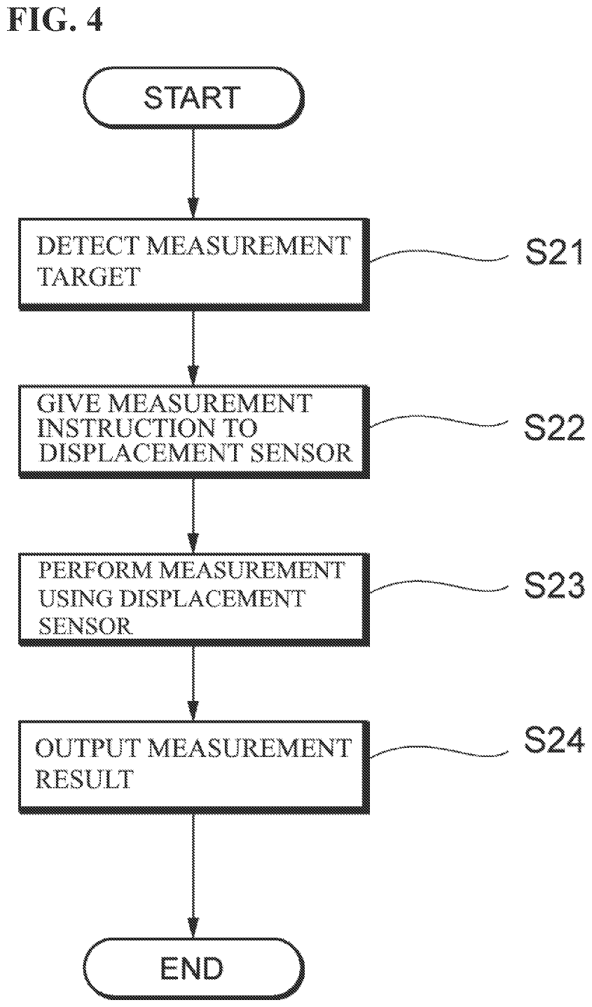

FIG. 4 is a flowchart showing a procedure for measuring the measurement target T with use of the sensor system 1 that uses the displacement sensor 10 according to the present disclosure. As shown in FIG. 4, this procedure is for the case of the aforementioned externally synchronized measurement mode and includes steps S21 to S24.

In step S21, the sensor system 1 detects the measurement target T, which is an object to be measured. Specifically, the control signal input sensor 12 detects that the measurement target T has moved to a predetermined position on a production line.

In step S22, the sensor system 1 gives an instruction to measure the measurement target T detected in step S21, with use of the displacement sensor 10. Specifically, the control signal input sensor 12 indicates the timing of measuring the measurement target T detected in step S21 by outputting an on/off signal to the control device 11. The control device 11 outputs a measurement timing signal to the displacement sensor 10 based on the on/off signal to give an instruction to measure the measurement target T.

In step S23, the displacement sensor 10 measures the measurement target T. Specifically, the displacement sensor 10 measures the measurement target T based on the measurement instruction received in step S22.

In step S24, the sensor system 1 outputs the result of measurement in step S23. Specifically, the displacement sensor 10 causes the display unit 31 to display the result of measurement processing, and/or outputs the result to the control device 11, the externally connected device 13, or the like via the external I/F unit 33.

Note that the above description has been given, with reference to FIG. 4, of the procedure in the case of the externally synchronized measurement mode in which the measurement target T is measured upon the control signal input sensor 12 detecting the measurement target T. However, there is no limitation thereto. In the case of the internally synchronized measurement mode, for example, an instruction to measure the measurement target T is given to the displacement sensor 10 upon a measurement timing signal being generated based on a preset period, instead of steps S21 and S22.

Next, a description will be given of the principle by which the displacement sensor 10 according to the present disclosure measures the measurement target T.

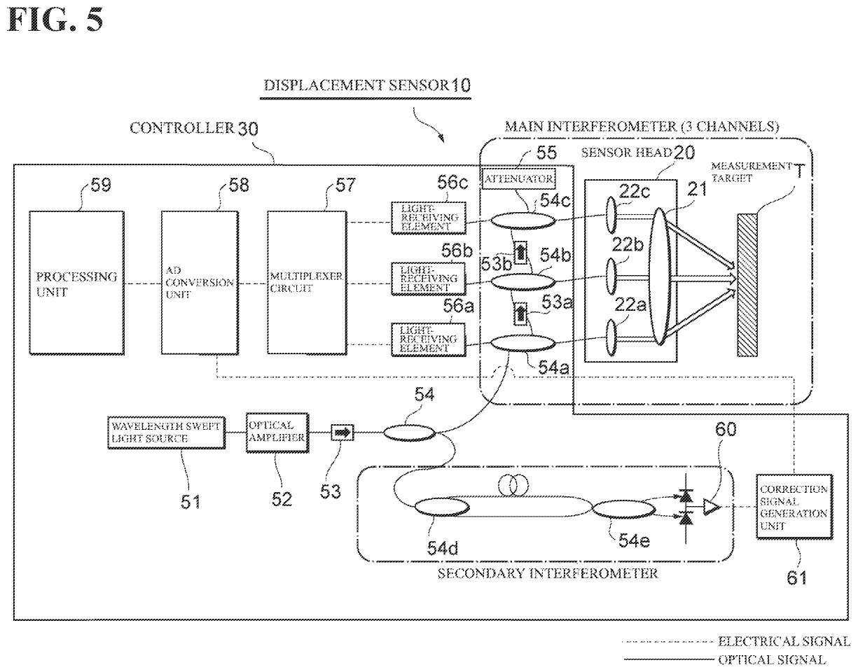

FIG. 5 is a diagram illustrating a principle by which the displacement sensor 10 according to the present disclosure measures a measurement target T. As shown in FIG. 5, the displacement sensor 10 includes the sensor head 20 and the controller 30. The sensor head 20 includes the objective lens 21 and a plurality of collimating lenses 22a to 22c. The controller 30 includes a wavelength-swept light source 51, an optical amplifier 52, a plurality of isolators 53, 53a, and 53b, a plurality of optical couplers 54 and 54a to 54e, an attenuator 55, a plurality of light-receiving elements (e.g., photodetectors (PD)) 56a to 56c, a multiplexer circuit 57, an analog-to-digital (AD) conversion unit (e.g., analog-to-digital converter) 58, a processing unit (e.g., processor) 59, a balance detector 60, and a correction signal generation unit 61.

The wavelength-swept light source 51 projects a wavelength-swept laser beam. The wavelength-swept light source 51 can be realized at low cost by, for example, applying a method of modulating a VCSEL (Vertical Cavity Surface Emitting Laser) with current since mode hopping is unlikely to occur due to a short resonator length, and the wavelength can be easily varied.

The optical amplifier 52 amplifies the beam projected from the wavelength-swept light source 51. The optical amplifier 52 is an EDFA (erbium-doped fiber amplifier), for example, and may be an optical amplifier dedicated to 1550 nm, for example.

The isolator 53 is an optical element through which an incident light beam is unidirectionally transmitted, and may immediately follow the wavelength-swept light source 51 in order to prevent the effect of noise generated by return beams.

Thus, the light beam projected from the wavelength-swept light source 51 is amplified by the optical amplifier 52, passes through the isolator 53, and is split into beams proceeding to a main interferometer and a secondary interferometer by the optical coupler 54. For example, the optical coupler 54 may split the light beam into the beams proceeding to the main and secondary interferometers at a ratio of 90:10 to 99:1.

The light beam that is split and proceeds to the main interferometer is further split into a beam in a direction toward the measurement target T and a beam in a direction toward the second-stage optical coupler 54b by the first-stage optical coupler 54a.

The light beam that is split in the direction toward the measurement target T by the first-stage optical coupler 54a passes through the collimating lens 22a and the objective lens 21 from the leading end of an optical fiber cable in the sensor head 20, and is radiated toward the measurement target T. Then, a light beam reflected at a reference surface, which is the leading end (end face) of this optical fiber cable, interferes with a light beam reflected at the measurement target T, and an interference beam is generated. The generated interference beam returns to the first-stage optical coupler 54a, and is thereafter received by the light-receiving element 56a and converted into an electrical signal.

The light beam that is split in the direction toward the second-stage optical coupler 54b by the first-stage optical coupler 54a proceeds toward the second-stage optical coupler 54b via the isolator 53a, and is further split in a direction toward the sensor head 20 by the second-stage optical coupler 54b. The light beam that is split in the direction toward the sensor head 20 passes through the collimating lens 22b and the objective lens 21 from the leading end of an optical fiber cable in the sensor head 20, as with the first stage, and is radiated toward the measurement target T. Then, a light beam reflected at a reference surface, which is the leading end (end face) of this optical fiber cable, interferes with a light beam reflected at the measurement target T, and an interference beam is generated. The generated interference beam returns to the second-stage optical coupler 54b, and is split into beams in a direction toward the isolator 53a and a direction toward the light-receiving element 56b by the optical coupler 54b. The light beam that is split in the direction toward the light-receiving element 56b is received by the light-receiving element 56b and converted into an electrical signal. Meanwhile, the isolator 53a is configured to transmit a light beam from the previous-stage optical coupler 54a toward the latter-stage optical coupler 54b and cut off a light beam from the latter-stage optical coupler 54b toward the previous-stage optical coupler 54a. Therefore, the beam split in the direction toward the isolator 53a is cut off.

The light beam that is split in the direction toward the third-stage optical coupler 54c by the second-stage optical coupler 54b proceeds toward the third-stage optical coupler 54c via the isolator 53b, and is further split in the direction toward the sensor head 20 by the third-stage optical coupler 54c. The light beam that is split in the direction toward the sensor head 20 passes through the collimating lens 22c and the objective lens 21 from the leading end of an optical fiber cable in the sensor head 20, as with the first and second stages, and is radiated toward the measurement target T. Then, a light beam reflected at the reference surface, which is the leading end (end face) of this optical fiber cable, interferes with a light beam reflected at the measurement target T, and an interference beam is generated. The generated interference beam returns to the third-stage optical coupler 54c, and is split into beams in a direction toward the isolator 53b and a direction toward the light-receiving element 56c by the optical coupler 54c. The light beam that is split in the direction toward the light-receiving element 56c is received by the light-receiving element 56c and converted into an electrical signal. Meanwhile, the isolator 53b is configured to transmit a light beam from the previous-stage optical coupler 54b toward the latter-stage optical coupler 54c and cut off a light beam from the latter-stage optical coupler 54c toward the previous-stage optical coupler 54b. Therefore, the beam split in the direction toward the isolator 53b is cut off.

Note that the light beam that is split in a direction other than the direction toward the sensor head 20 by the third-stage optical coupler 54c is not used to measure the measurement target T. Therefore, it is favorable to attenuate this light beam with the attenuator 55, which is a terminator or the like, so as not to be reflected and returned.

Thus, the main interferometer is an interferometer that has three stages of optical paths (three channels) each having an optical path length difference that is twice (round trip) the distance from the leading end (end face) of the optical fiber cable of the sensor head 20 to the measurement target T, and three interference beams corresponding to respective optical path length differences are generated.

The light-receiving elements 56a to 56c receive the interference beams from the main interferometer and generate electrical signals in accordance with the amount of light of the light beams received, as mentioned above.

The multiplexer circuit 57 multiplexes the electrical signals output from the light-receiving elements 56a to 56c.

The AD conversion unit 58 receives the electrical signal from the multiplexer circuit 57 and converts this electrical signal from an analog signal to a digital signal (AD conversion). Here, the AD conversion unit 58 performs AD conversion based on a correction signal from the correction signal generation unit 61 of the secondary interferometer.

The secondary interferometer obtains the interference signal in order to correct wavelength nonlinearities during the sweep with the wavelength-swept light source 51, and generates a correction signal called a K-clock.

Specifically, the light beam that is split and proceeds to the secondary interferometer by the optical coupler 54 is further split by the optical coupler 54d. Here, the optical paths of the split light beams are configured to have an optical path length difference using optical fiber cables with different lengths between the optical couplers 54d and 54e, and an interference beam corresponding to the optical path length difference is output from the optical coupler 54e, for example. The balance detector 60 receives the interference beam from the optical coupler 54e, and amplifies the optical signal and converts it to an electrical signal while removing noise by taking a difference from a signal of the opposite phase.

Note that the optical coupler 54d and the optical coupler 54e may split the light beam at a ratio of 50:50.

The correction signal generation unit 61 ascertains the wavelength nonlinearities during the sweep with the wavelength-swept light source 51 based on the electrical signal from the balance detector 60, generates a K-clock corresponding to the nonlinearities, and outputs the generated K-clock to the AD conversion unit 58.

Due to the wavelength nonlinearities during the sweep with the wavelength-swept light source 51, the wave intervals of the analog signal input to the AD conversion unit 58 from the main interferometer are not equal. The AD conversion unit 58 performs AD conversion (sampling) while correcting the sampling time based on the aforementioned K-clock so that the wave intervals are equal intervals.

Note that the K-clock is a correction signal used to sample the analog signal of the main interferometer, as mentioned above. Therefore, the K-clock needs to be generated so as to have a higher frequency than the analog signal of the main interferometer. Specifically, the optical path length difference provided between the optical coupler 54d and the optical coupler 54e in the secondary interferometer may be longer than optical path length differences between the leading ends (end faces) of the optical fiber cables in the main interferometer and the measurement target T. Alternatively, the correction signal generation unit 61 may increase the frequency by multiplication (e.g., by a factor of 8, etc.).

The processor 59 obtains the digital signal that has been subjected to AD conversion with its nonlinearities corrected by the AD conversion unit 58, and calculates displacement of the measurement target T (distance to the measurement target T) based on this digital signal. Specifically, the processor 59 performs frequency conversion on the digital signal using fast Fourier transform (FFT), and calculates the distance by analyzing them. The details of processing at the processor 59 will be described later.

Note that the processor 59 is required to perform high-speed processing, and is therefore realized by an integrated circuit such as an FPGA (field-programmable gate array) in many cases.

Here, the multiplexer circuit 57 is arranged on the upstream side of the AD conversion unit 58, but may alternatively be arranged on the downstream side of the AD conversion unit 58. The output from the plurality of light-receiving elements 56a to 56c may be separately subjected to AD conversion and then multiplexed by the multiplexer circuit 57.

Also, here, three stages of optical paths are provided in the main interferometer. The sensor head 20 radiates measurement beams from the respective optical paths toward the measurement target T, and the distance to the measurement target T, for example, is measured based on interference beams (return beams) obtained from the respective optical paths (multichannel). The number of channels in the main interferometer is not limited to three, and may alternatively be one or two, or may be four or more.

### Configuration of Sensor Head

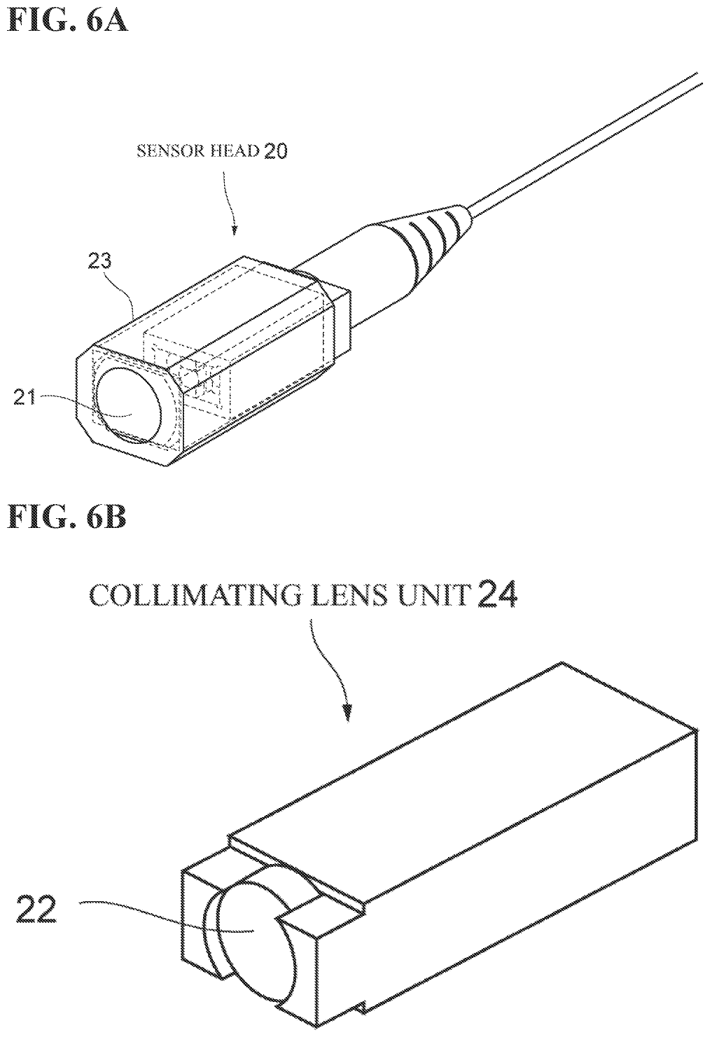

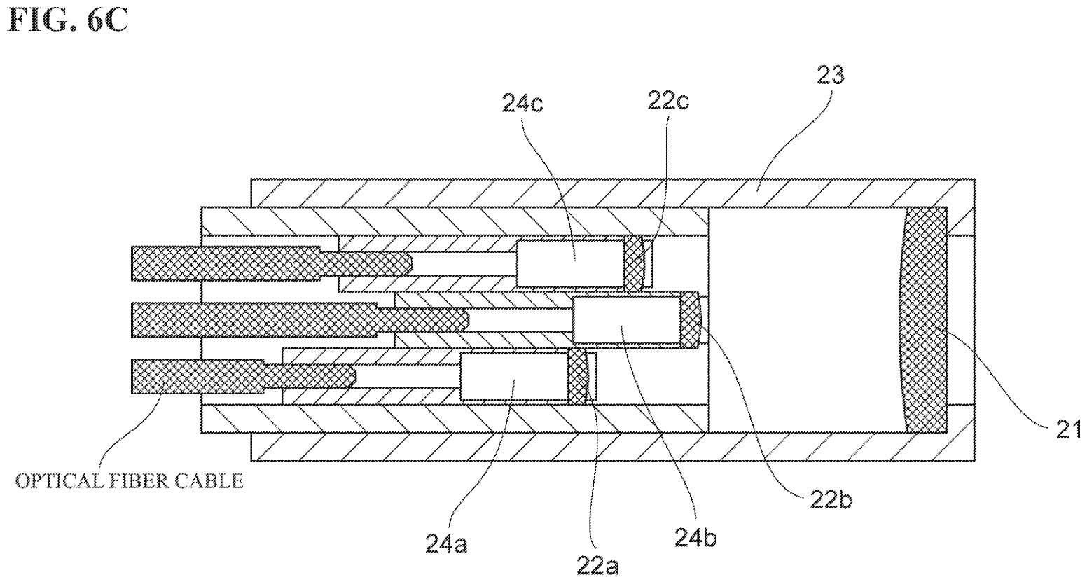

Here, a structure of the sensor head used in the displacement sensor 10 will be described. FIG. 6A is a perspective view showing a schematic configuration of the sensor head 20. FIG. 6B is a perspective view of a schematic configuration of a collimating lens holder arranged within the sensor head 20. FIG. 6C is a cross-sectional view of an internal structure of the sensor head.

In the sensor head 20, the objective lens 21 and the collimating lenses are accommodated in an objective lens holder 23, as shown in FIG. 6A. For example, the individual sides of the objective lens holder 23 that surround the objective lens 21 are about 10 mm long, and the objective lens holder 23 is about 22 mm in length in the optical axis direction.

As shown in FIG. 6B, a collimating lens unit 24 is formed by adhering a collimating lens 22 to the collimating lens holder using an adhesive material. The spot diameter can be adjusted by inserting an optical fiber cable, in accordance with the amount of insertion. The diameter of each collimating lens 22 is about 2 mm, for example.

Three collimating lenses 22a to 22c are held by the collimating lens holder, constituting collimating lens units 24a to 24c, and three optical fiber cables are inserted into the respective collimating lens units 24a to 24c in correspondence with the three collimating lenses 22a to 22c, as shown in FIG. 6C. Note that the three optical fiber cables may alternatively be held by the collimating lens holder.

These optical fiber cables and the collimating lens units 24a to 24c are held together with the objective lens 21 by the objective lens holder 23 and constitute the sensor head 20.

Here, the three collimating lens units are shifted with respect to each other so as to form different optical path length differences in terms of their positions in the optical axis direction in the sensor head 20, as shown in FIG. 6C.

The objective lens holder 23 and the collimating lens units 24a to 24c that constitute the sensor head 20 may be made of a metal (e.g., A2017) that has high strength and can be processed with high accuracy.

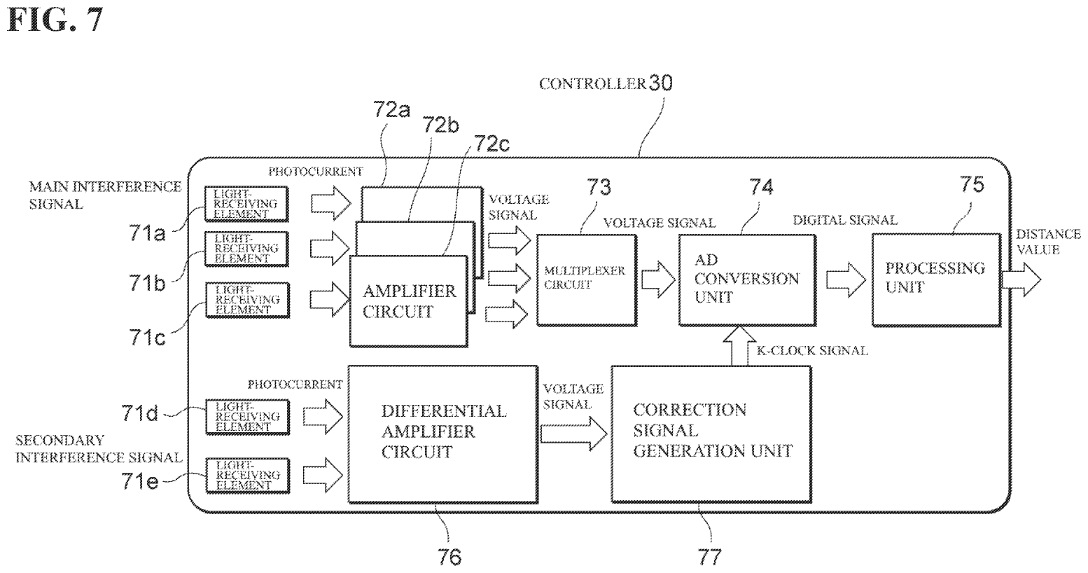

FIG. 7 is a block diagram illustrating signal processing in the controller 30. As shown in FIG. 7, the controller 30 includes a plurality of light-receiving elements 71a to 71e, a plurality of amplifier circuits 72a to 72c, a multiplexer circuit 73, an AD conversion unit 74, a processor 75, a differential amplifier circuit 76, and a correction signal generation unit 77.

In the controller 30, the light beam projected from the wavelength-swept light source 51 is split into a beam proceeding to the main interferometer and a beam proceeding to the secondary interferometer by the optical coupler 54, and the value of the distance to the measurement target T is calculated by processing main interference signals and secondary interference signals obtained respectively from the main and secondary interferometers, as illustrated in FIG. 5.

The plurality of light-receiving elements 71a to 71c correspond to the light-receiving elements 56a to 56c shown in FIG. 5, receive the main interference signals from the main interferometer, and output the received signals as current signals to the amplifier circuits 72a to 72c, respectively.

The plurality of amplifier circuits 72a to 72c convert the current signals to voltage signals (I-V conversion) and amplify these signals.

The multiplexer circuit 73 multiplexes the voltage signals output from the amplifier circuits 72a to 72c and outputs the multiplexed signal as one voltage signal to the AD conversion unit 74.

The AD conversion unit 74 corresponds to the AD conversion unit 58 shown in FIG. 5, and converts the voltage signal to a digital signal (AD conversion) based on a K-clock from the later-described correction signal generation unit 77.

The processor 75 corresponds to the processor 59 shown in FIG. 5, converts the digital signal from the AD conversion unit 74 to a frequency by means of FFT, analyzes the frequency, and calculates the value of the distance to the measurement target T.

The plurality of light-receiving elements 71d to 71e and the differential amplifier circuit 76, which correspond to the balance detector 60 shown in FIG. 5, receive interference beams in the secondary interferometer, output interference signals one of which has an inverted phase, and amplify the interference signals and convert these signals to a voltage signal while removing noise by taking a difference between the two signals.

The correction signal generation unit 77 corresponds to the correction signal generation unit 61 shown in FIG. 5, binarizes the voltage signal using a comparator, generates a K-clock, and outputs the generated K-clock to the AD conversion unit 74. The K-clock needs to be generated so as to have a higher frequency than the analog signal of the main interferometer. Therefore, the correction signal generation unit 77 may increase the frequency by multiplication (e.g., by a factor of 8 etc.).

Although the multiplexer circuit 73 in the controller 30 shown in FIG. 7 is arranged on the upstream side of the AD conversion unit 74, it may alternatively be arranged on the downstream side of the AD conversion unit 74. The output from the plurality of light-receiving elements 71a to 71c and the plurality of amplifier circuits 72a to 72c may be subjected to AD conversion, and may thereafter be multiplexed by the multiplexer circuit 73.

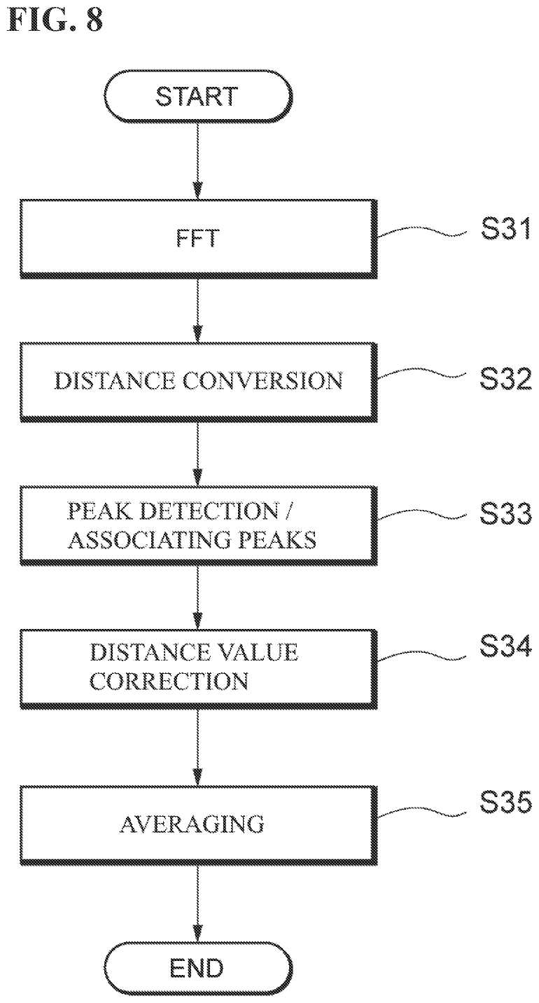

FIG. 8 is a flowchart showing a method for calculating the distance to the measurement target T that is executed by the processor 59 in the controller 30. This method includes steps S31 to S35, as shown in FIG. 8.

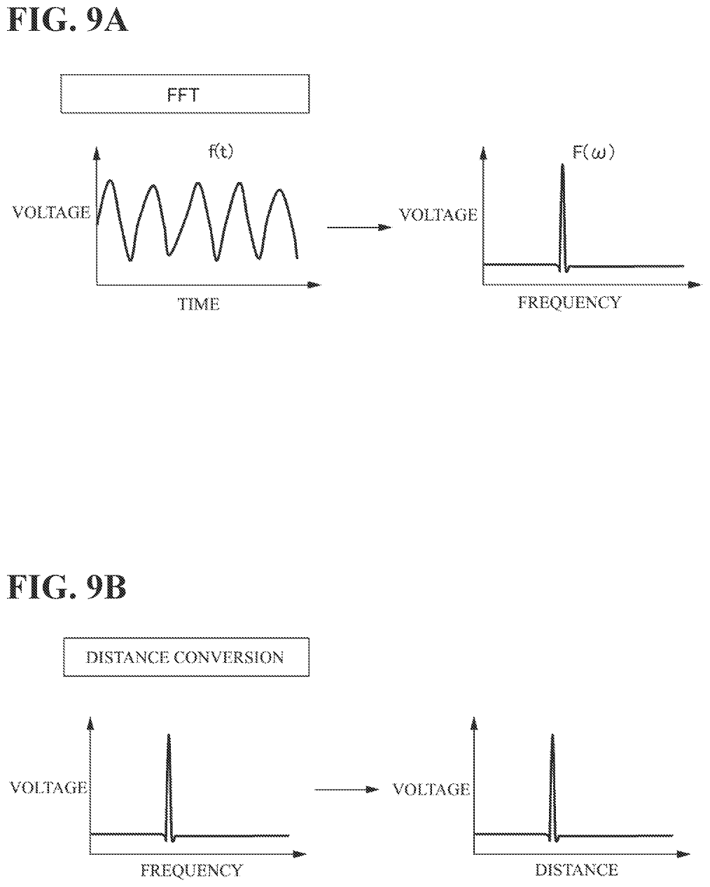

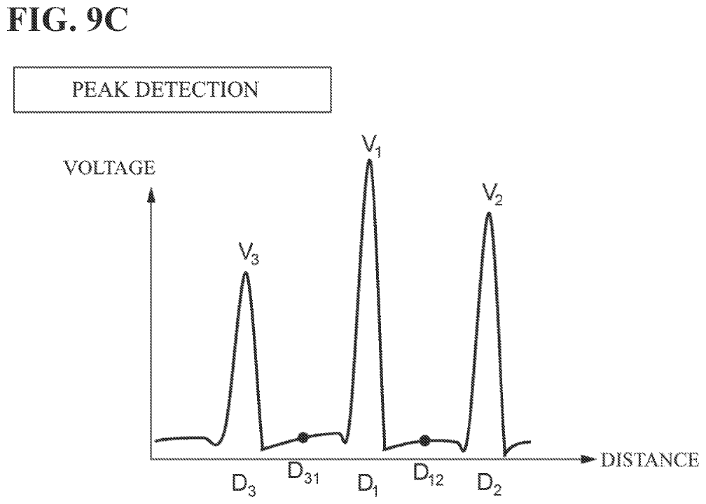

In step S31, the processor 59 performs frequency conversion on a waveform signal (voltage vs time) into a spectrum (voltage vs frequency) by means of the following Fast Fourier Transform (FFT). FIG. 9A shows how the waveform signal (voltage vs time) is subjected to frequency conversion into the spectrum (voltage vs frequency).

$${\sum }_{t = 0}^{N - 1} f ( t ) exp ( - i \frac{2 πω t}{N} ) = F ( ω ) \qquad ( Equation 1 )$$

where N=the number of data points

In step S32, the processor 59 performs distance conversion on the spectrum (voltage vs frequency) into a spectrum (voltage vs distance). FIG. 9B shows how the spectrum (voltage vs frequency) is subjected to distance conversion into the spectrum (voltage vs distance).

In step S33, the processor 59 calculates values (distance value, SNR) corresponding to peaks based on the spectrum (voltage vs distance). FIG. 9C shows how the values (distance, SNR) corresponding to peaks are calculated based on the spectrum (voltage vs distance).

(1) Peak values of voltage are calculated. Specifically, pairs (Dx, Vx) of a distance value and a voltage value at a distance at which the differential value of the voltage goes from positive to negative are created with respect to the voltage shown in FIG. 9C, and are arranged in descending order of the voltage value, i.e., (D1, V1), (D2, V2), (D3, V3), . . . , (Dn, Vn)

(2) Any combination with which the number of multiple heads is exceeded is excluded. For example, the displacement sensor 10 is provided with three stages of optical paths in the main interferometer, the sensor head 20 radiates measurement beams from the respective optical paths toward the measurement target T, and interference beams (return beams) obtained from the respective optical paths are received (the number of multiple heads=3), as shown in FIG. 5. If there are four or more peaks, any peak in excess of three derives from noise, and may therefore be excluded from the calculation target. If the number of multiple heads is three, the pairs are (D1, V1), (D2, V2), and (D3, V3).

(3) The obtained pairs are rearranged in the order of distance. If the pairs are arranged in the ascending order of distance, they are arranged in the order of (D3, V3), (D1, V1), and (D2, V2).

(4) Peak-to-peak voltages are obtained. Specifically, a voltage V31 at an intermediate distance D31 between D3 and D1 is obtained, and a voltage V12 at an intermediate distance D12 between D1 and D2 is obtained. Then, an average voltage Vn of these voltages is calculated with an expression: Vn=(V31+V12)/2.

(5) Respective SNRs are calculated. Specifically, the following SNRs are obtained: SN1=V1/Vn, SN2=V2/Vn, and SN3=V3/Vn.

Thus, the values corresponding to the peaks are calculated as (distance value, SNR)=(D1, SN1), (D2, SN2), (D3, SN3) based on the spectrum (voltage vs. distance).

Returning to FIG. 8, in step S34, the processor 59 corrects the distance values out of the values (distance value, SNR) corresponding to the peaks that are calculated in step S33. Specifically, the three collimating lens units 24a to 24c (collimating lenses 22a to 22c and the optical fiber cables) are shifted from each other in terms of the position in the optical axis direction of the sensor head 20, as shown in FIG. 6C. Therefore, the distance values D1, D2, and D3 corresponding to the respective peaks are corrected in accordance with the shift amounts (e.g., h1, h2, h3 etc.).

As a result, the values corresponding to the peaks are calculated as (corrected distance value, SNR)=(D1+h1, SN1), (D2+h2, SN2), (D3+h3, SN3).

In step S35, the processor 59 averages the distance values out of the values corresponding to the peaks (corrected distance value, SNR) that are calculated in step S34. Specifically, it is favorable that the processor 59 averages those corrected distance values with an SNR that has at least a threshold value out of the values (corrected distance value, SNR) corresponding to the peaks, and outputs the result of the averaging calculation as the distance to the measurement object T.

Next, a specific embodiment of the present disclosure will be described in detail, focusing on more characteristic configurations, functions, and properties. Note that the following optical interference range sensor corresponds to the displacement sensor 10 described with reference to FIGS. 1 to 9. Some or all of the basic configurations, functions, and properties included in the present optical interference range sensor are common to the configurations, functions, and properties included in the displacement sensor 10 described with reference to FIGS. 1 to 9.

### First Embodiment

### Configuration of Optical Interference Range Sensor

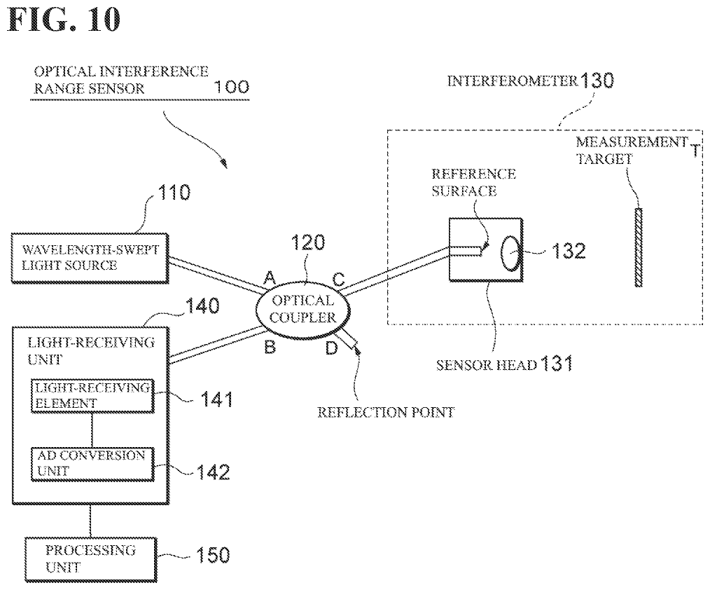

FIG. 10 is a schematic diagram showing an overview of a configuration of an optical interference range sensor 100 according to one or more embodiments. As shown in FIG. 10, the optical interference range sensor 100 includes a wavelength-swept light source 110, an optical coupler 120, an interferometer 130, a light-receiving unit 140, and a processor 150. The optical coupler 120 has a first port A to a fourth port D. The interferometer 130 has a sensor head 131. Further, an objective lens 132 is attached to or included in the sensor head 131. Note that the sensor head 131 may also include a collimating lens arranged between a leading end of an optical fiber cable and the objective lens 132. The light-receiving unit 140 includes a light-receiving element 141 and an AD conversion unit 142.

The wavelength-swept light source 110 is connected to the first port A of the optical coupler 120 and projects a light beam while continuously varying the wavelength thereof.

The optical coupler 120 splits the light beam projected by the wavelength-swept light source 110 and input to the first port A into light beams proceeding to the third port C and the fourth port D, and outputs the split light beams.

The light beam output from the third port C of the optical coupler 120 is input to the sensor head 131 via an optical fiber cable and radiated as a measurement beam toward the measurement target T via the objective lens 132, and is reflected at the measurement target T. The reflected beam (first reflected beam) reflected at the measurement target T is focused by the objective lens 132 of the sensor head 131, and returns from the sensor head 131 to the third port C of the optical coupler 120.

The light beam output from the third port C of the optical coupler 120 is input to the sensor head 131 via the optical fiber cable, but a part of the light beam also serves as a reference beam and is reflected at a reference surface. Here, a leading end of the optical fiber cable serves as the reference surface, and a reflected beam (second reflected beam) reflected at this reference surface returns from the sensor head 131 to the third port C of the optical coupler 120.

At this time, the light beam output from the third port C of the optical coupler 120 is input to the sensor head 131 via the optical fiber cable. The measurement beam is radiated toward the measurement target T and returns as the first reflected beam from the sensor head 131 to the third port C of the optical coupler 120. The reference beam is reflected at the reference surface to become the second reflected beam, and returns from the sensor head 131 to the third port C of the optical coupler 120. As a result, an interference beam is generated in accordance with the optical path length difference between the measurement beam and the reference beam. In other words, the interferometer 130 generates an interference beam from the first reflected beam and the second reflected beam, and outputs the interference beam as a return beam to the third port C of the optical coupler 120. Note that both the optical path lengths of the measurement beam and the reference beam may have values obtained by multiplying the spatial length of the optical path by a refractive index.

Meanwhile, the light beam output from the fourth port D of the optical coupler 120 is reflected at a reflection point, which is present at an end of an optical fiber cable connected to the fourth port D, and returns as a reflected beam to the fourth port D.

Then, the interference beam input to the third port C and the reflected beam input to the fourth port D are coupled by the optical coupler 120 and output from the second port B of this optical coupler 120.

The light-receiving unit 140 receives the light beam output from the second port B of the optical coupler 120. In the light-receiving unit 140, the light-receiving element 141, which is, for example, a photodetector, receives the light beam output from the second port B of the optical coupler 120 and converts the received beam to an electrical signal. The AD conversion unit 142 converts this electrical signal from an analog signal to a digital signal.

The processor 150 calculates the distance to the measurement target T based on the digital signal converted by the light-receiving unit 140. For example, the processor 150 is a processor realized by an integrated circuit such as an FPGA, and performs frequency conversion on the input digital signal by means of FFT and calculates the distance to the measurement target T based on the frequency conversion result.

Here, there are cases where the light beam received by the light-receiving unit 140 includes not only the interference beam that is generated by interference between the first and second reflected beams of the measurement beam and the reference beam by the interferometer 130, but also unnecessary signals whose level is increased by phase noise caused due to, for example, a temporal error of the interference beam and the effect of the reflected beam from the fourth port D of the optical coupler 120.

In this embodiment, the effect of phase noise is eliminated when the processor 150 calculates the distance to the measurement target T through the configuration and arrangement of the optical coupler 120, the interferometer 130, and the optical fiber cable that connects them in the optical interference range sensor 100 so that the distance to the measurement target T can be calculated with high accuracy.

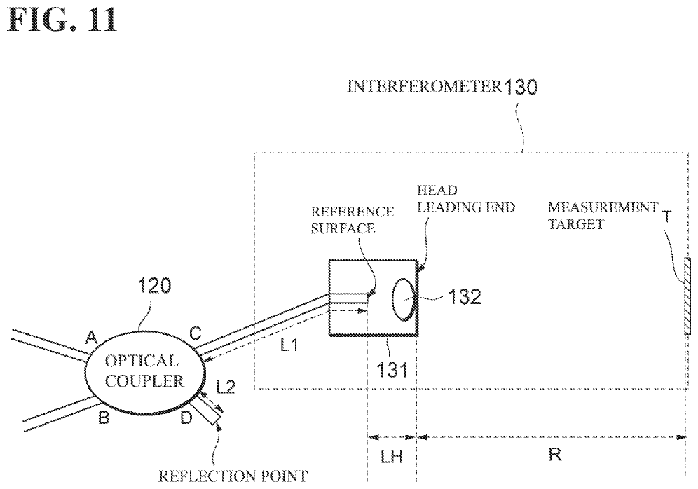

FIG. 11 is a diagram showing a configuration and an arrangement of the optical coupler 120, the interferometer 130, and the optical fiber cable that connects them in the optical interference range sensor 100. As shown in FIG. 11, the optical coupler 120, the interferometer 130, and the optical fiber cable that connects them are configured and arranged so as to satisfy the following Equation 2, where L1 denotes the optical path length from the third port C of the optical coupler 120 to the reference surface, L2 denotes the optical path length from the fourth port D of the optical coupler 120 to the reflection point, LH denotes the optical path length from the reference surface to the leading end of the sensor head 131 that radiates the measurement beam toward the measurement target T, and R denotes the measurement range for the measurement target T. Note that all of the optical path lengths L1, L2, and LH may have values obtained by multiplying the spatial length of the optical path by the refractive index.

L1−L2>(LH+R)*2 or L1−L2<LH*2 (Equation 2)

Specifically, the measurement range R indicates the range in which the distance from the leading end of the housing of the sensor head 131 to the measurement target T can be measured. The measurement range R is determined from a frequency range in which a certain level of the SN ratio of the signal can be ensured and that is supported by the hardware. If, for example, the fourth port D is configured within the optical coupler 120, L2 is set to 0.

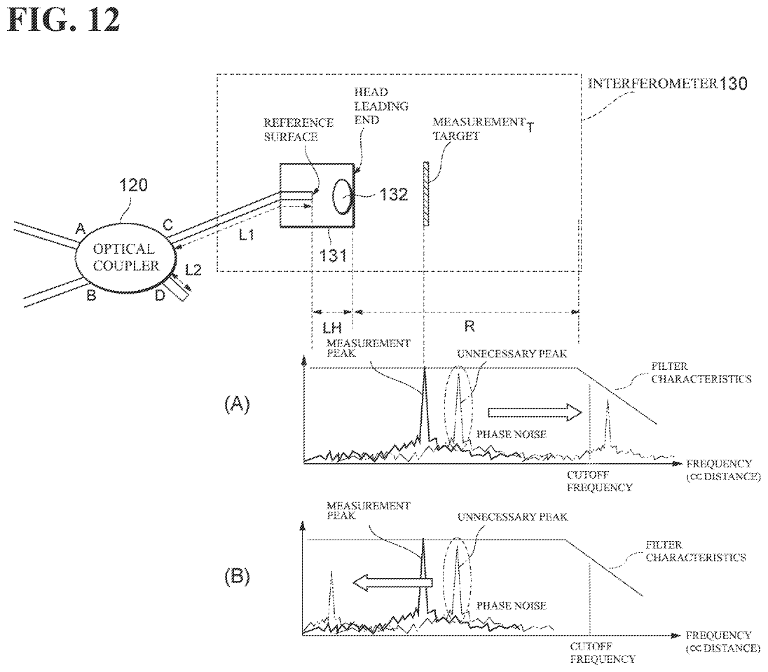

FIG. 12 shows the relationship between a signal waveform received by the light-receiving unit 140 and processed by the processor 150 and the measurement range R for the measurement target T that is calculated by the processor 150. If the optical coupler 120, the interferometer 130, and the optical fiber cable that connects them are configured and arranged so as to satisfy L1−L2>(LH+R)*2 of the aforementioned Equation 2, an unnecessary signal peak caused by the effect of phase noise is eliminated from the measurement range R for the measurement target T in the signal waveform received by the light-receiving unit 140 and processed by the processor 150. Note that, here, the measurement range R is defined as a band (e.g., cutoff frequency) of an analog filter.

Specifically, the unnecessary signal peak caused by the effect of phase noise moves beyond the measurement range R, as shown in FIG. 12A. Therefore, the processor 150 can measure the measurement peak in the measurement range R with high accuracy when calculating the distance to the measurement target T.

Further, if the optical coupler 120, the interferometer 130, and the optical fiber cable that connects them are configured and arranged so as to satisfy L1−L2<LH*2 of the aforementioned Equation 2, an unnecessary signal peak caused by the effect of phase noise is eliminated from the measurement range R for the measurement target T in the signal waveform received by the light-receiving unit 140 and processed by the processor 150.

Specifically, the unnecessary signal peak caused by the effect of the effect of the phase noise does not reach the measurement range R (i.e., is moved to the inner side of the leading end of the housing of the sensor head 131), as shown in FIG. 12B. Therefore, the processor 150 can measure the measurement peak in the measurement range R with high accuracy when calculating the distance to the measurement target T.

As described above, with the optical interference range sensor 100 according to the first embodiment, the optical coupler 120, the interferometer 130, and the optical fiber cable that connects them in the optical interference range sensor 100 are configured and arranged under a predetermined condition (so as to satisfy the Equation 2). Thus, an unnecessary signal peak caused by the effect of phase noise can be eliminated from the measurement range R for the measurement target T in the signal waveform received by the light-receiving unit 140 and processed by the processor 150. As a result, a measurement peak in the measurement range R for the measurement target T can be measured with high accuracy.

In addition, the optical interference range sensor 100 can measure the distance to the measurement object T with high accuracy with use of the optical coupler 120, and does not therefore need to use an expensive circulator. As a result, a cost reduction can be achieved.

Note that, here, the optical coupler 120 has the first port A to the fourth port D as elements for splitting and coupling light beams, and is a 2×2 optical coupler. However, the optical coupler 120 is not limited thereto, and may alternatively be a 3×3 optical coupler, for example.

Specifically, when a 3×3 optical coupler is used, the light beam projected from the wavelength-swept light source 110 and input to the first port A is split into three light beams, i.e., not only beams proceeding to the third port C and the fourth port D of the 3×3 optical coupler but also a beam proceeding to yet another port (e.g., additional port E). The additional port E of the 3×3 optical coupler has a reflection point at an end of this additional port E, as the fourth port D does. Here, L3 denotes the optical path length from the additional port E of the 3×3 optical coupler to this reflection point.

In this case, the 3×3 optical coupler, the interferometer 130, and the optical fiber cable that connects them are favorably configured and arranged so as to satisfy the aforementioned Equation 2 and the following Equation 3.

L1−L3>(LH+R)*2 or L1−L3<LH*2 (Equation 3)

Thus, even if the number of ports increases as a result of using a 3×3 optical coupler as the optical coupler 120, configuring and arranging the optical coupler, the interferometer 130, and the optical fiber cable that connects them so as to satisfy predetermined conditions (Equations 2 and 3) enables an unnecessary signal peaks caused by the effect of phase noise to be eliminated from the measurement range R for the measurement target T in the signal waveform received by the light-receiving unit 140 and processed by the processor 150.

The light beam projected from the wavelength-swept light source 110 is split into beams proceeding to the third port C and the fourth port D of the optical coupler 120. Here, an optical coupler may be used that splits the light beam so that the ratio between the light beam that is split and proceeds to the third port C and the light beam that is split and proceeds to the fourth port D is 10:90 to make the power of the former light beam smaller than the power of the latter light beam.

With this configuration, the power of the light beam that is split and proceeds to the second port B of the optical coupler 120 connected to the light-receiving unit 140 is large (in this case, 90% of the return beam) when the return beam from the interferometer 130 that is input to the third port C of the optical coupler 120 is transmitted to the light-receiving unit 140 via the optical coupler 120. As a result, the amount of light of the light beam received by the light-receiving unit 140 is large, and the processor 150 can calculate the distance to the measurement target T with higher accuracy.

Note that the ratio between the light beams that are split and proceed respectively to the third port C and the fourth port D of the optical coupler 120 is not limited to 10:90, and may be any ratio as long as the amount of light of the light beam received by the light-receiving unit 140 is not smaller than a predetermined value and the processor 150 is capable of highly accurate calculation.

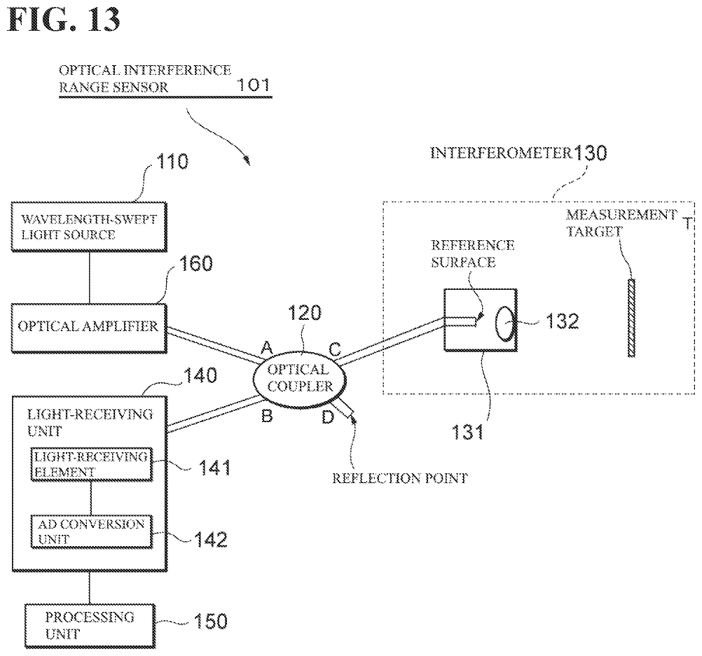

Also, the optical interference range sensor 100 may additionally include an optical amplifier. FIG. 13 is a schematic diagram showing an overview of a configuration of an optical interference range sensor 101, which is the optical interference range sensor 100 shown in FIG. 10 that additionally includes an optical amplifier 160. As shown in FIG. 13, the optical amplifier 160 is provided between the wavelength-swept light source 110 and the optical coupler 120.

In general, optical sensors including optical interference range sensors radiate a light beam toward a measurement target to be measured and measure the distance thereto and displacement thereof. Here, the light beam radiated toward the measurement target is preferably an eye-safe laser. Meanwhile, the larger the amount of light of the light beam received by the light-receiving unit 140 is, the clearer the signal waveform used to calculate the distance to the measurement target T becomes, thus enabling the processor 150 to calculate the distance to the measurement target T with higher accuracy.

The optical amplifier 160 favorably amplifies (adjusts) the light beam projected by the wavelength-swept light source 110 while maintaining the eye-safe laser so that the light-receiving unit 140 receives the light beam with high efficiency. Thus, the distance to the measurement target T can be calculated with higher accuracy safely with an increased SNR while maintaining the eye-safe laser.

If, for example, the aforementioned optical coupler 120 is configured to split a light beam so that the ratio between the light beam proceeding to the third port C and the light beam proceeding to the fourth port D is 10:90, and the power of the light beam radiated toward the measurement target T is small, the optical amplifier 160 may amplify (adjust) the power of the light beam projected from the wavelength-swept light source 110 within a range in which the eye-safe laser is maintained.

Note that a reflection point is present at an end of the optical fiber cable connected to the fourth port D of the optical coupler 120 in the optical interference range sensor 100 according to the first embodiment described above with reference to FIG. 10. This reflection point will be described in detail.

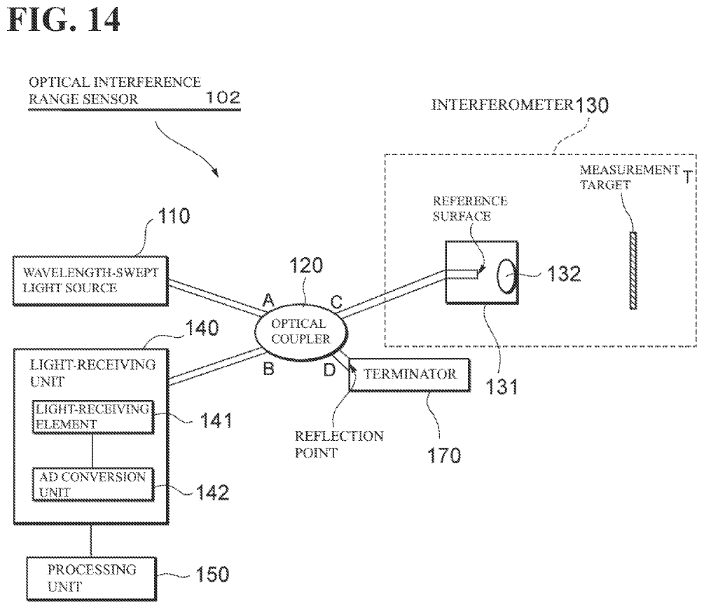

FIG. 14 is a schematic diagram showing an overview of a configuration of an optical interference range sensor 102, which is the optical interference range sensor 100 shown in FIG. 10 with a terminator 170 connected to an end of the optical fiber cable that is connected to the fourth port D of the optical coupler 120. As shown in FIG. 14, the terminator 170 is connected to the end of the optical fiber cable that is connected to the fourth port D.

The terminator 170 attenuates the light beam that is split and proceeds to the fourth port D of the optical coupler 120, and reduces reflected beams toward the optical coupler 120. The aforementioned effect of phase noise can be reduced by reducing the reflected beam, and the optical interference range sensor 102 can measure the distance to the measurement target T with higher accuracy.

Note that the optical fiber cable connected to the fourth port D is welded to the terminator 170, thus further reducing reflected beams.

The optical element connected to the end of the optical fiber cable connected to the fourth port D is not limited to the terminator 170. If another optical element is connected and a connection portion or the like is formed at which the refractive index changes, this portion can serve as a reflection point that reflects light beams from the fourth port D.

For example, an isolator may alternatively be connected, or the fiber leading end of the optical fiber cable may be processed and a coreless fiber or the like may be applied thereto. In these cases as well, it is favorable to reduce the aforementioned effect of the phase noise by reducing reflected beams proceeding to the optical coupler 120c by applying fusion connection, APC polishing, or the like, for example.

### Second Embodiment

Next, the second embodiment will describe an optical interference range sensor with multiple heads, which is the optical interference range sensor 100 described in the first embodiment but having a multi-stage configuration. The present embodiment omits detailed descriptions of configurations common to the first embodiment, and focuses mainly on differences from the first embodiment.

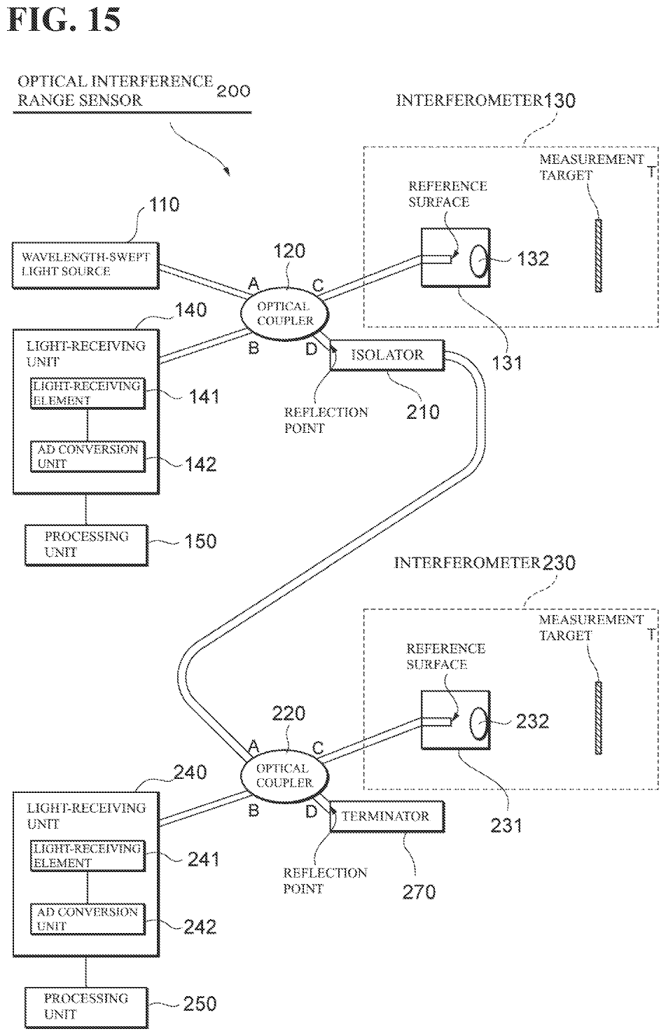

FIG. 15 is a schematic diagram showing an overview of a configuration of an optical interference range sensor 200 according to the second embodiment. As shown in FIG. 15, the optical interference range sensor 200, which includes the optical interference range sensor 100 described in the first embodiment, additionally has an isolator 210 connected to the fourth port D of the optical coupler 120 and also includes a second optical coupler 220, a second interferometer 230, a second light-receiving unit 240, a second processor 250, and a terminator 270. Note that the second coupler 220 has a first port A to a fourth port D. The second interferometer 230 has a second sensor head 231. A second objective lens 232 is attached to or included in the second sensor head 231. The second light-receiving unit 240 includes a second light-receiving element 241 and a second AD conversion unit 242.

The isolator 210 is connected to the fourth port D of the optical coupler 120, and guides, to the first port A of the second optical coupler 220, a light beam that is split and proceeds to the fourth port D by the optical coupler 120, of the light beam that is projected with its wavelength continuously varied by the wavelength-swept light source 110.

The second optical coupler 220 splits the light beam guided from the isolator 210 to the first port A into beams proceeding to the third port C and the fourth port D, and outputs the split light beams. Here, if the optical coupler 120 is configured to split the light beam so that the ratio between the light beam proceeding to the third port C and the light beam proceeding to the fourth port D is 10:90, and the light beam guided from the isolator 210 to the first port A of the second optical coupler 220 has sufficient power.

The light beam output from the third port C of the second optical coupler 220 is input to the second sensor head 231 via an optical fiber cable, and is radiated as a measurement beam toward the measurement target T via the second objective lens 232 and is reflected at the measurement target T. The reflected beam (third reflected beam) reflected at the measurement target T is focused by the second objective lens 232 of the second sensor head 231, and returns from the second sensor head 231 to the third port C of the second optical coupler 220.

Further, the light beam output from the third port C of the second optical coupler 220 is input to the second sensor head 231 via an optical fiber cable, but a part of the light beam also serves as a reference beam and is reflected at a reference surface. Here, a leading end of the optical fiber cable serves as the reference surface, and a reflected beam (fourth reflected beam) reflected at this reference surface returns from the second sensor head 231 to the third port C of the second optical coupler 220.

Thus, as the interferometer 130 described in the first embodiment does, the second interferometer 230 generates an interference beam (second interference beam) by interference between the third reflected beam and the fourth reflected beam, and outputs the generated interference beam as a return beam to the third port C of the second optical coupler 220.

Meanwhile, the light beam output from the fourth port D of the second optical coupler 220 is reflected at a connecting portion (second reflection point) between the terminator 270 and an end of the optical fiber cable connected to the fourth port D, and returns as a reflected light beam to the fourth port D.

Then, the interference beam input to the third port C and the reflected beam input to the fourth port D are coupled by the second optical coupler 220 and output from the second port B of the second optical coupler 220.

The second light-receiving unit 240 receives the light beam output from the second port B of the second optical coupler 220 with use of the second light-receiving element 241, converts the received light beam into an electrical signal, and then converts this electrical signal from an analog signal to a digital signal with use of the second AD conversion unit 242, as the light-receiving unit 140 described in the first embodiment does.

The second processor 250 calculates the distance to the measurement target T based on the digital signal converted by the second light-receiving unit 240, as the processor 150 described in the first embodiment does. The calculation method is the same as that of the first embodiment, and a detailed description thereof is omitted.

Here, the configuration and the arrangement of the second optical coupler 220, the second interferometer 230, and the optical fiber cable that connects them in the optical interference range sensor 200 according to the present embodiment are the same as the configuration and the arrangement of the optical coupler 120, the interferometer 130, and the optical fiber cable that connects them in the optical interference range sensor 100 according to the first embodiment. Specifically, the second optical coupler 220, the second interferometer 230, and the optical fiber cable that connects them are configured and arranged so as to satisfy L1−L2>(LH+R)*2 or L1−L2<LH*2, as described above with reference to FIGS. 11 and 12.

As described above, with the optical interference range sensor 200 according to the second embodiment, an unnecessary signal peak caused by the effect of phase noise can be eliminated from the measurement range R for the measurement target T in the signal waveform received by the second light-receiving unit 240 and processed by the second processor 250, as with the optical interference range sensor 100 according to the first. As a result, a measurement peak in the measurement range R for the measurement target T can be measured with high accuracy.

Further, the optical interference range sensor 200 functions as an optical interference range sensor having multiple heads of a two-stage configuration, and can therefore carry out distance measurement with higher accuracy based on the distances to the measurement target T that are calculated by the processor 150 and the second processor 250.

Note that the optical interference range sensor in this embodiment has multiple heads of a two-stage configuration, but there is no limitation to this configuration. For example, an optical interference range sensor having multiple heads of a three or more-stage configuration is also possible.

Here, the sensor head 131 and the second sensor head 231 are schematically shown in an independent manner mainly to facilitate understanding of the optical paths in the optical coupler 120 and the second optical coupler 220, but there is no limitation to this configuration. For example, one sensor head may have a plurality of optical fiber cables, optical paths, collimating lenses, and so on, as shown in FIGS. 5 and 6A to 6C.

The optical interference range sensors described in the first and second embodiments may be used as displacement sensors, distance meters, lidars, or the like for measuring the distance to the measurement target T.

The above-described embodiments are for facilitating the understanding of one or more embodiments, and is not intended to interpret one or more embodiments in a limiting manner. The elements provided by the embodiments, and the arrangements, materials, conditions, shapes, sizes, and the like of these elements are not limited to those described as examples, and may be modified as appropriate. The configurations described in different embodiments can be partially replaced or combined.

### Supplementary Note

One or more embodiments may further include an optical interference range sensor (100) including:

an optical coupler (120) having at least four ports and configured to split a light beam and to couple light beams;

a light source (110) connected to a first port of the optical coupler and configured to project a light beam while continuously varying a wavelength thereof;

an interferometer (130) configured to generate an interference beam by interference between a first reflected beam and a second reflected beam, the first reflected beam being obtained as a result of a light beam that is split and proceeds to a third port of the optical coupler, of the light beam projected from the light source and input to the first port of the optical coupler, being radiated as a measurement beam toward a measurement target and reflected at the measurement target, the second reflected beam being obtained as a result of a reference beam, of the light beam that is split and proceeds to the third port of the optical coupler, being reflected at a reference surface;

a reflection point configured to reflect a light beam that is split and proceeds to a fourth port of the optical coupler, of the light beam projected from the light source and input to the first port of the optical coupler;

a light-receiving unit (140) configured to receive a light beam obtained as a result of the interference beam from the third port and a reflected beam reflected at the reflection point from the fourth port being coupled and output to a second port of the optical coupler, and to convert the received light beam into an electrical signal; and

a processor (150) configured to calculate a distance to the measurement target based on the electrical signal converted by the light-receiving unit,

wherein an optical path length, denoted by L1, from the third port of the optical coupler to the reference surface, an optical path length, denoted by L2, from the fourth port of the optical coupler to the reflection point, an optical path length, denoted by LH, from the reference surface to a leading end of a sensor head configured to radiate the measurement beam toward the measurement target, and a measurement range, denoted by R, for the measurement target are set such that the expression:

L1−L2>(LH+R)*2 or L1−L2<LH*2

is satisfied.

### LIST OF REFERENCE NUMERALS

1 Sensor system
10 Displacement sensor
11 Control device
12 Control signal input sensor
13 Externally connected device
20 Sensor head
21 Objective lens
22, 22a to 22c Collimating lens
23 Objective lens holder
24, 24a to 24c Collimating lens unit
30 Controller
31 Display unit
32 Setting unit
33 External interface (I/F) unit
34 Optical fiber cable connector
35 External storage unit
36 Measurement processing unit
40 Optical fiber cable
51 Wavelength-swept light source
52 Optical amplifier
53, 53a to 53b Isolator
54, 54a to 54j Optical coupler
55 Attenuator
56a to 56c Light-receiving element
57 Multiplexer circuit
58 AD conversion unit
59 Processor
60 Balance detector
61 Correction signal generation unit
71a to 71e Light-receiving element
72a to 72c Amplifier circuit
73 Multiplexer circuit
74 AD conversion unit
75 Processor
76 Differential amplifier circuit
77 Correction signal generation unit
100 to 102, 200 Optical interference range sensor
110 Wavelength-swept light source
120, 220 Optical coupler
130, 230 Interferometer
131, 231 Sensor head
132, 232 Objective lens
140, 240 Light-receiving unit
141, 241 Light-receiving element
142, 242 AD conversion unit
150, 250 Processor
160 Optical amplifier
170, 270 Terminator
210 Isolator
A to E Port of optical coupler
L1 to L3, LH Optical path length
R Measurement range
T Measurement target

1. An optical interference range sensor comprising:
an optical coupler comprising at least four ports and configured to split a light beam and to couple light beams;
a light source connected to a first port of the optical coupler and configured to project a light beam while continuously varying a wavelength thereof;
an interferometer configured to generate an interference beam by interference between a first reflected beam and a second reflected beam, the first reflected beam being obtained as a result of a light beam that is split and proceeds to a third port of the optical coupler, of the light beam projected from the light source and input to the first port of the optical coupler, being radiated as a measurement beam toward a measurement target and reflected at the measurement target, the second reflected beam being obtained as a result of a reference beam, of the light beam that is split and proceeds to the third port of the optical coupler, being reflected at a reference surface;
a reflection point configured to reflect a light beam that is split and proceeds to a fourth port of the optical coupler, of the light beam projected from the light source and input to the first port of the optical coupler;
a light-receiving unit configured to receive a light beam obtained as a result of the interference beam from the third port and a reflected beam reflected at the reflection point from the fourth port being coupled and output to a second port of the optical coupler, and to convert the received light beam into an electrical signal; and
a processor configured to calculate a distance to the measurement target based on the electrical signal converted by the light-receiving unit,
wherein one or more of an optical path length, denoted by L1, from the third port of the optical coupler to the reference surface, an optical path length, denoted by L2, from the fourth port of the optical coupler to the reflection point, an optical path length, denoted by LH, from the reference surface to a leading end of a sensor head configured to radiate the measurement beam toward the measurement target, and a measurement range, denoted by R, for the measurement target are set such that the expression:
L1−L2>(LH+R)*2 or L1−L2<LH*2
is satisfied.

2. The optical interference range sensor according to claim 1,
wherein the reference surface is an end face of an optical fiber cable connecting the third port of the optical coupler to the sensor head.

3. The optical interference range sensor according to claim 1,
wherein, of the light beam projected from the light source and input to the first port of the optical coupler, a power of the light beam that is split and proceeds to the third port of the optical coupler is smaller than a power of the light beam that is split and proceeds to the fourth port.

4. The optical interference range sensor according to claim 1, further comprising:
an optical amplifier configured to amplify the light beam projected from the light source, the optical amplifier being located between the light source and the first port of the optical coupler.

5. The optical interference range sensor according to claim 1,
wherein the reflection point is a terminator.

6. The optical interference range sensor according to claim 1,
wherein the reflection point is an isolator.

7. The optical interference range sensor according to claim 6, further comprising:
a second optical coupler configured to split a light beam and to couple light beams, and having at least four ports comprising a first port connected to the isolator;
a second interferometer configured to generate a second interference beam by interference between a third reflected beam and a fourth reflected beam, the third reflected beam being obtained as a result of a light beam that is split and proceeds to a third port of the second optical coupler, of a light beam guided by the isolator and input to the first port of the second optical coupler, being radiated as a measurement beam toward a measurement target and reflected at the measurement target, the fourth reflected beam being obtained as a result of a reference beam, of the light beam that is split and proceeds to the third port of the second optical coupler, being reflected at a reference surface;
a second reflection point configured to reflect a light beam that is split and proceeds to a fourth port of the second optical coupler, of the light beam guided by the isolator and input to the first port of the second optical coupler;
a second light-receiving unit configured to receive a light beam obtained as a result of the second interference beam from the third port of the second optical coupler and a reflected beam reflected at the second reflection point from the fourth port of the second optical coupler being coupled and output to a second port of the second optical coupler, and to convert the received light beam into an electrical signal; and
a second processor configured to calculate a distance to the measurement target based on the electrical signal converted by the second light-receiving unit.

8. The optical interference range sensor according to claim 2,
wherein, of the light beam projected from the light source and input to the first port of the optical coupler, a power of the light beam that is split and proceeds to the third port of the optical coupler is smaller than a power of the light beam that is split and proceeds to the fourth port.

9. The optical interference range sensor according to claim 2, further comprising:
an optical amplifier configured to amplify the light beam projected from the light source, the optical amplifier being located between the light source and the first port of the optical coupler.

10. The optical interference range sensor according to claim 3, further comprising:
an optical amplifier configured to amplify the light beam projected from the light source, the optical amplifier being located between the light source and the first port of the optical coupler.

11. The optical interference range sensor according to claim 8, further comprising:
an optical amplifier configured to amplify the light beam projected from the light source, the optical amplifier being located between the light source and the first port of the optical coupler.

12. The optical interference range sensor according to claim 2,
wherein the reflection point is a terminator.

13. The optical interference range sensor according to claim 3,
wherein the reflection point is a terminator.

14. The optical interference range sensor according to claim 4,
wherein the reflection point is a terminator.

15. The optical interference range sensor according to claim 8,
wherein the reflection point is a terminator.

16. The optical interference range sensor according to claim 9,
wherein the reflection point is a terminator.

17. The optical interference range sensor according to claim 10,
wherein the reflection point is a terminator.

18. The optical interference range sensor according to claim 2,
wherein the reflection point is an isolator.

19. The optical interference range sensor according to claim 3,
wherein the reflection point is an isolator.

20. The optical interference range sensor according to claim 4,
wherein the reflection point is an isolator.
